(19) United States
(12) Patent Application Publication
(10) Pub. No.: US 2019/0274481 A1
(43) Pub. Date: Sep. 12, 2019

(54) High-Speed Food Processor and Stirring Cup Thereof

(71) Applicant: WEIJIE HAN, CIXI CITY, ZHEJIANG PROVINCE (CN)

(72) Inventor: WEIJIE HAN, CIXI CITY, ZHEJIANG PROVINCE (CN)

(21) Appl. No.: 16/319,338

(22) PCT Filed: Jul. 19, 2016
(86) PCT No.: PCT/CN2016/090531

§ 371 Date: Jan. 19, 2019

(51) Int. Cl. A47J 43/046; A47J 43/07

(52) U.S. Cl. CPC A47J 43/046; A47J 43/0716

(57) ABSTRACT

A high-speed food processor and a vacuum stirring cup thereof, the high-speed food processor comprising the vacuum stirring cup and a main machine, the vacuum stirring cup comprising a cup body and a cup cover detachably sealed at an open end of the cup body, wherein an outer side of the cup body is provided with a hollow handle with an evacuating device provided therein; and a vacuum pump connection base is further provided on an electric motor connection base for connecting the cup body to the main machine in a matched manner, with an upper end of the evacuating device being in communication with an inner cavity of the cup body, and a lower end thereof being in communication with the vacuum pump connection base.

### TECHNICAL FIELD

The present application relates to a food processor and specifically relates to a high-speed food processor and a stirring cup thereof.

### BACKGROUND ART

The application range of the high-speed food processor is wider and wider; however, a certain heat may be generated due to high-speed rotation of a stirring blade in a working process of the high-speed food processor, so that food such as fruit juice or vegetable juice is easy to oxidize to affect the taste.

In view of this, there is an urgent need to improve the structure of an existing food processor to increase an evacuating function, so that the food such as the fruit juice or the vegetable juice has better taste.

### SUMMARY OF THE INVENTION

The technical problem to be solved by the present application is that the existing food processor has no evacuating function to affect the taste of the fruit juice or vegetable juice.

In order to solve the technical problem, the technical scheme adopted by the present application is that disclosed is a vacuum stirring cup of a high-speed food processor, the vacuum stirring cup comprising a cup body and a cup cover detachably sealed at an open end of the cup body, wherein an outer side of the cup body is provided with a handle, the cup body is provided with an evacuating device, a vacuum pump connection base is further provided on a connection base for connecting the cup body to the main machine in a matched manner, with an upper end of the evacuating device being in communication with an inner cavity of the cup body, and a lower end thereof being in communication with the vacuum pump connection base.

In the vacuum stirring cup, the handle is provided with a hollow structure formed by a detachable handle cover, and the evacuating device is provided in the hollow structure.

In the vacuum stirring cup, an inner protruded part is provided on an upper end of a part, opposite to the handle, and on an inner wall of the cup body, the inner protruded part is provided with an air suction channel, the air suction channel is composed of a vertical through hole and a horizontal through hole which are in communication with each other, an upper end of the vertical through hole is provided on a top face of the inner protruded part, and the horizontal through hole is connected to the executing device.

In the vacuum stirring cup, a residue preventing cover is inserted to the upper end of the vertical through hole, an upper end of the inner protruded part is provided with a sunken step, an outer side of the sunken step is provided with an inner recess, the residue preventing cover is provided with a horizontal cover plate, an outer side of the cover plate is provided with a side plate adapted to the inner recess in the outer side of the sunken step, a bottom center of the cover plate is provided with a plug pin, and the plug pin is inserted to the vertical through hole.

In the vacuum stirring cup, a step face of the sunken step and a side of the inner recess are provided with ridges so as to form a ventilation channel by which air in the inner cavity of the cup body enters the vertical through hole.

In the vacuum stirring cup, an air suction connection base comprises a shell and a sealing device provided in the shell, an inner cavity of the sealing device is provided with a horizontal diaphragm, a central through hole is formed in the center of the horizontal diaphragm, a bottom face of the diaphragm is provided with at least one circle of end face annular ridge around the central through hole, and an end face seal is formed between the end face annular ridge and a top face of the vacuum pump connection base; and an inner wall of the sealing device is provided with at least one circle of side annular ridge, and a side seal is formed between the side annular ridge and a side of the vacuum pump connection base.

In the vacuum stirring cup, the executing device comprises an upper air suction pipe and a lower air suction pipe between which a one-way valve assembly is connected, and the one-way valve assembly comprises:

a valve cover with an outer side wall provided with an air suction pipe for connecting the lower air suction pipe;
a valve base provided inside the valve cover, wherein an outer side wall of the valve base is provided with an air inlet pipe for connecting the upper air suction pipe, and the air inlet pipe extends out of the valve cover; the valve base is cylindrical and is provided with a through hole in a center, an upper end face of the through hole is upwards protruded to form a cylindrical protruded part, and a section of a top face of the protruded part is triangular;
and a valve element provided in the valve base, wherein the valve element is composed of three parts including a valve cap, a valve column and a check ring from top to bottom, a bottom face of the valve cap is provided with an annular flange, the valve column is mounted in the through hole of the valve base, a gap is provided between the valve column and an inner wall of the through hole, and the gap is in communication with the air inlet pipe to form an air inlet cavity; and the gap between the valve column and an inner cavity of the valve base is in communication with the air suction pipe to form an air suction cavity, the protruded part supports against a lower end face of the annular flange to form a sealing face for isolating the air suction cavity from the air inlet cavity.

In the vacuum stirring cup, a center of the cup cover is provided with a vacuum display and purge valve assembly.

The present application further provides a high-speed food processor comprising a main machine and a stirring cup connected to the main machine in a matched manner, a vacuum pump is provided in the main machine, and the stirring cup is any one stirring cup of the high-speed food processor.

The high-speed food processor further comprises a connection hose connected to an evacuating container.

In the present application, with the evacuating device additionally provided on the stirring cup of the high-speed food processor, the high-speed food processor has an executing function, and food is broken and stirred in a vacuum state and is not oxidized so as to have good taste.

### BRIEF DESCRIPTION OF THE DRAWINGS

FIG. 1 is a schematic diagram of a high-speed food processor in the present application;

FIG. 2 is an exploded structural schematic diagram of the high-speed food processor as shown in FIG. 1;

FIG. 3 is a structural schematic diagram of a cup cover in the present application;

FIG. 4 is an exploded structural schematic diagram of the cup cover in the present application;

FIG. 5 is a sectional view of the high-speed food processor in the present application;

FIG. 6 is a partly enlarged view (side view) of a residue preventing structure in the present application;

FIG. 7 is a partly enlarged view (front view) of the residue preventing structure in the present application;

FIG. 8 is a schematic diagram of a residue preventing cover in the present application;

FIG. 9 is an exploded structural schematic diagram of a one-way valve in the present application;

FIG. 10 is a sectional view of a one-way valve assembly in the present application;

FIG. 11 is a schematic diagram of an executing device in the present application;

FIG. 12 is a schematic diagram of an air suction connection base in the present application;

FIG. 13 is a sectional view of the air suction connection base in the present application;

FIG. 14 is an exploded structural schematic diagram of the air suction connection base in the present application;

FIG. 15 is a schematic diagram of connection of a main machine to an evacuating container by a connection hose in the present application.

### DETAILED DESCRIPTION OF THE INVENTION

The present application provides a high-speed food processor and a vacuum stirring cup thereof, the high-speed processing of food materials, such as fruits and vegetables, in the vacuum stirring cup in an evacuated state can be realized, so that the food in the cup body is not oxidized and has high nutrition retention and good taste. The present application is described below in detail in combination with accompanying drawings of the description.

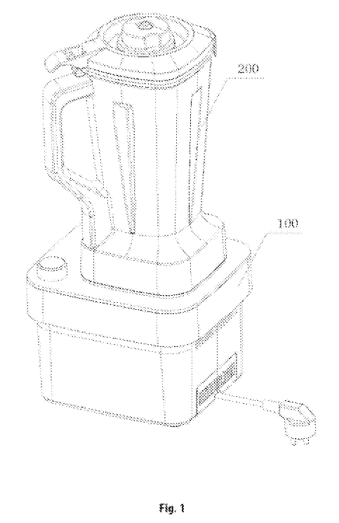

As shown in FIG. 1, the high-speed food processor provided by the present application comprises a main machine 100 and a vacuum stirring cup 200 connected to the main machine 100 in a matched manner, and the vacuum stirring cup 200 is used for breaking and stirring food materials, such as fruits and vegetables, in the cup body.

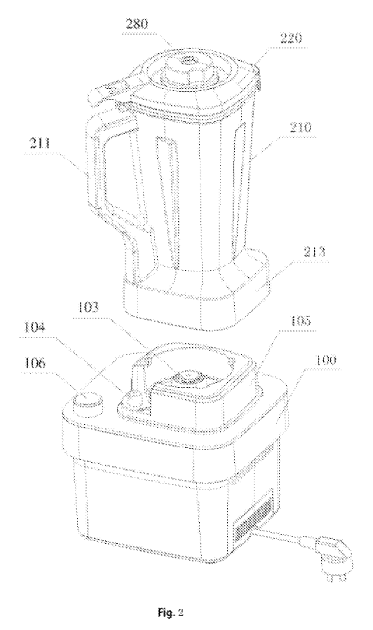

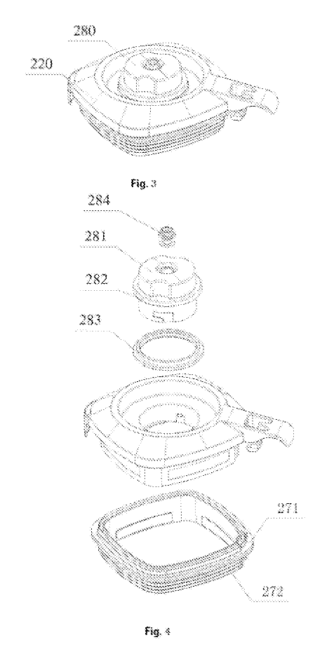

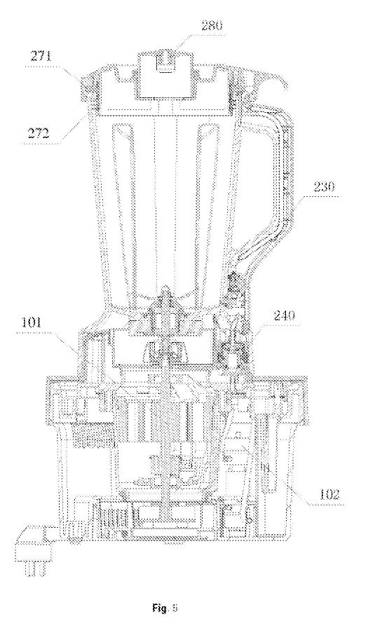

As shown in FIG. 2, FIG. 3, FIG. 4 and FIG. 5, the main machine 100 is internally provided with a stirring electric motor 101 and a vacuum pump 102, the vacuum stirring cup 200 is provided with an executing device, the vacuum stirring cup 200 is connected to the main machine 100 by an upper connection base and a lower connection base in a matched manner, the vacuum pump 102 is connected to the executing device in a sealing manner after the vacuum stirring cup 200 is connected to the main machine 100 in the matched manner, an inner cavity of the vacuum stirring cup 200 is executed, the stirring electric motor in the main machine 100 outputs power to a stirring blade of the vacuum stirring cup 200 to drive the stirring blade to rotate at high speed, so that the food materials, such as fruits and vegetables, in the vacuum stirring cup 200 are broken and stirred.

The upper connection base is provided on a top face of the main machine 100 and comprises an electric motor connection base 103 and a vacuum pump connection base 104, wherein the electric motor connection base 103 is provided on a top center of the main machine 100, and an output shaft of the stirring electric motor 101 is connected to a connection shaft of the stirring blade of the vacuum stirring cup 200 after upwards penetrating out of the electric motor connection base 103. A lower fence 105 is provided around an outer side of the electric motor connection base 103, a gap is formed in one corner of the lower fence 105, the vacuum pump connection base 104 is provided on the gap, and an air suction opening of the vacuum pump 102 is connected to the vacuum pump connection base 104 by a hose in a sealing manner.

The whole vacuum pump connection base 104 is shaped like a frustum which is thin at an upper part and thick at a lower part, so that it is convenient to realize connection, and meanwhile, the sealing performance is improved.

The main machine 100 is provided with a switch 106 used for starting the vacuum pump 102 and the stirring electric motor 101.

The vacuum stirring cup 200 comprises a cup body 210 and a cup cover 220 used for sealing an open end at an upper end of the cup body 210, an outer side of the cup body 210 is provided with a handle 211, and the handle 211 is used for placing the cup body 210. The handle 211 is of a hollow structure, the executing device is provided in the hollow structure of the handle 211, the handle 211 is packaged into the hollow structure by a handle body provided at a side of the cup body and a handle cover for covering, the executing device comprises an air suction assembly 230 and an air suction connection base 240, the air suction connection base 240 is internally provided with a sealing device connected to the vacuum pump connection base 104 in a matched manner.

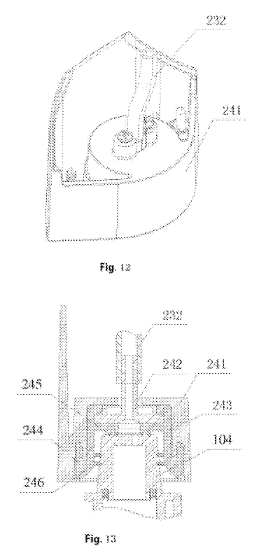

See FIG. 11 again, the air suction assembly 230 comprises an upper air suction pipe 231, a lower air suction pipe 232 and a one-way valve assembly 250 connected between the upper air suction pipe 231 and the lower air suction pipe 232. An upper end of the upper air suction pipe 231 is in communication with the inner cavity of the cup body 210, and the lower end of the lower air suction pipe 232 is connected to the air suction connection base 240.

A bottom face of the vacuum stirring cup 200 is provided with an upper fence 213, when the vacuum stirring cup 200 is connected to the main machine 100 in the matched manner, the upper fence 213 sleeves the outside of the lower fence 105 to realize positioning, and it is convenient to connect the upper connection base to the lower connection base in a matched manner, and the air suction connection base 240 is connected to the vacuum pump connection base 104 in a sealing manner.

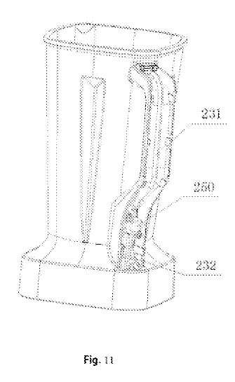

As shown in FIG. 9 and FIG. 10, the one-way valve assembly 250 comprises a valve cover 251 and a valve base 252 provided inside the valve cover 251, the valve base 252 is internally provided with a valve element 253, an outer side wall of the valve cover 251 is provided with an air suction pipe 254, the air suction pipe 254 is connected to the lower air suction pipe 232, an outer side wall of the valve base 252 is provided with an air inlet pipe 255, the air inlet pipe 255 is connected to the upper air suction pipe 231, a gap is further formed in an outer side wall of the valve cover 251 to make the air inlet pipe 255 extend out of the valve cover 251, an inner sealing ring 256 is provided between an inner end face of the valve base 252 and the valve cover 251, and a contact face of an outer end face of the valve base 252 and the handle is provided with an outer sealing ring 257.

The valve base 252 is cylindrical and is provided with a through hole in a center, an upper end face of the through hole is upwards protruded to form a cylindrical protruded part, a section of a top face of the protruded part is triangular, the valve element 253 is composed of three parts including a valve cap, a valve column and a check ring from top to bottom, a bottom face of the valve cap is provided with an annular flange of which the diameter is larger than that of the valve column, and a center of a bottom face of the valve element 253 is provided with a shaft hole (non-through hole) facilitating radial deformation when the valve element is mounted.

The valve column of the valve element 253 is partially mounted in the through hole of the valve base 252, a gap is provided between the valve column and an inner wall of the through hole, and the gap is in communication with the air inlet pipe 255 to form an air inlet cavity; and the gap between the valve column and an inner cavity of the valve base 252 is in communication with the air suction pipe 254 to form an air suction cavity, the protruded part supports against a lower end face of the annular flange to form a sealing face for isolating the air suction cavity from the air inlet cavity.

A working principle of the one-way valve is as follows:

when the vacuum pump works, air is sucked from the air suction pipe 232, then, the annular flange of the valve cap of the valve element 253 deforms under the action of pressure to upwarp, a bottom face of the annular flange leaves from the protruded part of the valve base 252, the sealing face is opened, and the air suction cavity is in communication with the air inlet cavity; when the vacuum pump stops working, the annular flange of the valve cap of the valve element 253 rebounds, with a bottom face thereof supporting against the protruded part on the valve base 252, so that the air suction cavity and the air inlet cavity are closed.

An inner protruded part is provided on a part, opposite to the handle 211, on an inner wall at an upper end of the cup body 210 and is provided with an air suction channel, the air suction channel is composed of a vertical through hole and a horizontal through hole which are in communication with each other, an upper end of the vertical through hole is provided on a top face of the inner protruded part, and the horizontal through hole is connected to an upper end of the upper air suction pipe 231 in the handle.

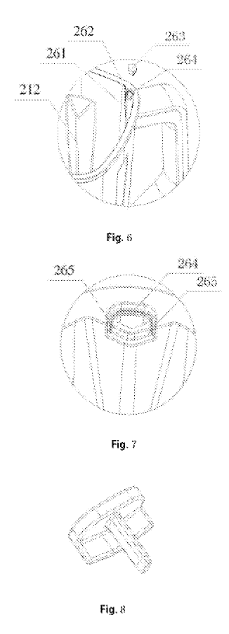

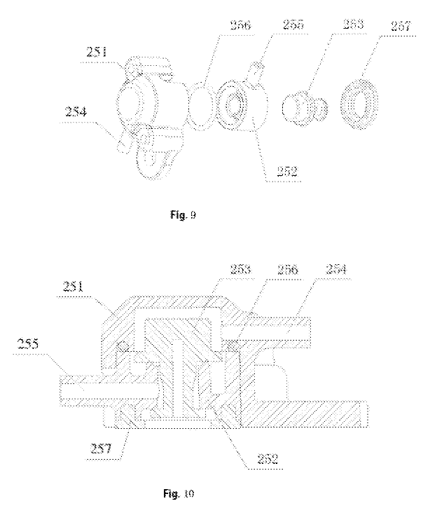

As shown in FIG. 6, FIG. 7 and FIG. 8, the upper end of the vertical through hole is provided with a residue preventing structure, the residue preventing structure comprises a sunken step 262 provided on an upper end of the inner protruded part 261 and a residue preventing cover 263 inserted to the vertical through hole, the sunken step is provided with an inner recess facing to a side of the inner cavity of the cup body, the residue preventing cover 263 is provided with a horizontal cover plate, an outer side of the cover plate is provided with a side plate adapted to the inner recess of the sunken step, the height of the side plate is smaller than that of the inner recess, and a bottom center of the cover plate is provided with a plug pin, and the plug pin is inserted to the vertical through hole.

A step face of the sunken step and a side of the inner recess are provided with ridges so as to form a ventilation channel by which air in the inner cavity of the cup body enters the vertical through hole. Meanwhile, the ridges are capable of effectively preventing broken food in the cup body from entering the vertical through hole. A specific structure in the embodiment is that the step face of the sunken step is provided with a horizontal ridge 264, the horizontal ridge 264 is located at a side, far away from the inner cavity of the cup body, of the vertical through hole, two ends of the horizontal ridge 264 downwards extend along a side surface of the inner recess to form a vertical ridge 265, and after the plug pin of the residue preventing cover 263 is inserted to the vertical through hole, the horizontal ridge 264 and the vertical ridge 265 respectively support against the cover plate and the side plate to form a ventilation channel by which the air in the inner cavity of the cup body enters the vertical through hole.

As shown in FIG. 6, an inner wall of the cup body 210 is further provided with a plurality of ribs 212 in a protruded manner, and the ribs 212 are shaped like triangular prisms and have sections gradually reduced from top to bottom, so that a stirring effect is improved.

As shown in FIG. 4 and FIG. 5, a center of the cup cover 220 is provided with a vacuum display and purge valve assembly 280, the vacuum display and purge assembly 280 comprises a valve cover 281, the middle of the valve cover 281 is provided with a shaft shoulder part 282, a lower part is sleeved with a sealing ring 283 and supports against a bottom face of the shaft shoulder part 282, a through hole is formed in the center of the valve cover 281, a silica plug 284 is provided in the through hole, the silica plug 284 is provided with an upwards-protruded hemispherical sac in the center and an annular flange at an upper part, the annular flange of the silica plug 284 tightly presses the valve cover 281 when the inside of the cup body is executed, so that the through hole in the center of the valve cover 281 is sealed, and the hemispherical sac is sunken under the action of pressure to display the executing degree. An outer side of an outer part of the valve cover 281 is provided with a rotary clamping groove, the valve cover 281 is mounted in the through hole in the center of the cup cover, the valve cover 281 is rotated to be clamped with the cup cover, the shaft shoulder part 282 tightly presses the sealing ring 283 to realize seal, after juicing is ended, the silica plug 284 is toggled left and right to make a part of the annular flange of the silica plug 284 upwarp, and then, outside air enters the cup body through the gap between a side of the silica plug 284 and the through hole in the center of the valve cover 281, so that the cup cover can be opened.

A lower part of the cup cover 220 is provided with an annular protruded part sleeved with a sealing assembly, the sealing assembly comprises a sleeve-shaped sealing body, an upper end of the sealing body is provided with an annular flange 271 to form an end face seal, an outer side of a lower part of the sealing body is provided with three circles of annular sheets 272, appearances of the annular sheets 272 and the appearance of an inner wall of the cup body are adapted to form a side seal, and the sealing effect is greatly improved due to the adoption of the double-seal structure.

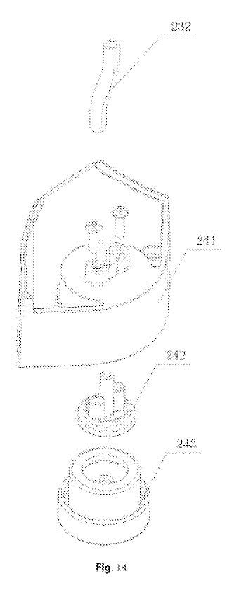

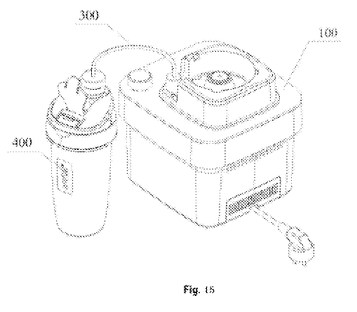

As shown in FIG. 12, FIG. 13 and FIG. 14, the air suction connection base 240 adopts the following structure:

the air suction connection base 240 comprises a shell 241 as well as a connection pipe 242 and a sealing device 243 which are provided in the shell, the sealing device 243 is made of a silica material and is shaped like a cylinder of which two ends are opened, an inner cavity of the sealing device is provided with a horizontal diaphragm, a central through hole is formed in the center of the horizontal diaphragm, an outer side of a lower end of the sealing device 243 is provided with an annular fence 244, a mounting groove adapted to the annular fence 244 is formed in the shell 241, the sealing device 243 is clamped in the mounting groove in the shell 241 by the annular fence 244, an upper end face of the sealing device is inwards shrunken to form a clamping groove together with a top face of the diaphragm, a lower end of the connection pipe 242 is provided with an annular flange clamped in the clamping groove, the connection pipe is fixed in the shell by using two bolts downwards penetrating through a top face of the shell, an upper end of the connection pipe 242 is connected to a lower connection pipe 232 after upwards penetrating out of the shell 241, a bottom face of the diaphragm is provided with two circles of end face annular ridges 245 around the central through hole, and an end face seal is formed between the end face annular ridges and a top face of the vacuum pump connection base 104; and an inner wall of the sealing device 243 is provided with two circles of side annular ridges 246, and a side seal is formed between the side annular ridges and a side of the vacuum pump connection base 104. The sectional sizes of the end face annular ridges 245 and the side annular ridges 246 gradually become small from roots to ends. One or more circles of end face annular ridges 245 and side annular ridges 246 can also be provided.

As shown in FIG. 15, the main machine 100 in the present application can also be directly connected to an executing container 400 by a connection hose 300 so as to be used, and the executing container 400 may be a container, such as a vacuum fresh keeping cup and a vacuum fresh keeping box.

The present application is not limited to the preferred embodiment, any one should know that structural changes which are made under the inspiration of the present application and have a same or similar technical solution with the present application fall into the scope of the present application.

1-10. (canceled)

11. A vacuum stirring cup of a high-speed food processor, comprising a cup body and a cup cover detachably sealed at an open end of the cup body, an outer side of the cup body being provided with a handle, wherein the cup body is provided with an evacuating device, a vacuum pump connection base is further provided on a connection base for connecting the cup body to the main machine in a matched manner, with an upper end of the evacuating device being in communication with an inner cavity of the cup body, and a lower end thereof being in communication with the vacuum pump connection base.

12. The stirring cup of the high-speed food processor of claim 11, wherein the handle is provided with a hollow structure formed by a detachable handle cover, and the evacuating device is provided in the hollow structure.

13. The stirring cup of the high-speed food processor of claim 12, wherein an inner protruded part is provided on an upper end of a part, opposite to the handle, and on an inner wall of the cup body, the inner protruded part is provided with an air suction channel, the air suction channel is composed of a vertical through hole and a horizontal through hole which are in communication with each other, an upper end of the vertical through hole is provided on a top side of the inner protruded part, and the horizontal through hole is connected to the executing device.

14. The stirring cup of the high-speed food processor of claim 13, wherein a residue preventing cover is inserted to the upper end of the vertical through hole, an upper end of the inner protruded part is provided with a sunken step, an outer side of the sunken step is provided with an inner recess, the residue preventing cover is provided with a horizontal cover plate, an outer side of the cover plate is provided with a side plate adapted to the inner recess in the outer side of the sunken step, a bottom center of the cover plate is provided with a plug pin, and the plug pin is inserted to the vertical through hole.

15. The stirring cup of the high-speed food processor of claim 14, wherein a step face of the sunken step and a side of the inner recess are provided with ridges so as to form a ventilation channel by which air in the inner cavity of the cup body enters the vertical through hole.

16. The stirring cup of the high-speed food processor of claim 11, wherein an air suction connection base comprises a shell and a sealing device provided in the shell, an inner cavity of the sealing device is provided with a horizontal diaphragm, a central through hole is formed in the center of the horizontal diaphragm, a bottom face of the diaphragm is provided with at least one circle of end face annular ridge around the central through hole, and an end face seal is formed between the end face annular ridge and a top face of the vacuum pump connection base; and an inner wall of the sealing device is provided with at least one circle of side annular ridge, and a side seal is formed between the side annular ridge and a side of the vacuum pump connection base.

17. The stirring cup of the high-speed food processor of claim 11, wherein the executing device comprises an upper air suction pipe and a lower air suction pipe between which a one-way valve assembly is connected, and the one-way valve assembly comprises:
a valve cover with an outer side wall provided with an air suction pipe for connecting the lower air suction pipe;
a valve base provided inside the valve cover, wherein an outer side wall of the valve base is provided with an air inlet pipe for connecting the upper air suction pipe, and the air inlet pipe extends out of the valve cover; the valve base is cylindrical and is provided with a through hole in a center, an upper end face of the through hole is upwards protruded to form a cylindrical protruded part, and a section of a top face of the protruded part is triangular;
and a valve element provided in the valve base, wherein the valve element is composed of three parts including a valve cap, a valve column and a check ring from top to bottom, a bottom face of the valve cap is provided with an annular flange, the valve column is mounted in the through hole of the valve base, a gap is provided between the valve column and an inner wall of the through hole, and the gap is in communication with the air inlet pipe to form an air inlet cavity; and the gap between the valve column and an inner cavity of the valve base is in communication with the air suction pipe to form an air suction cavity, the protruded part supports against a lower end face of the annular flange to form a sealing face for isolating the air suction cavity from the air inlet cavity.

18. The stirring cup of the high-speed food processor of claim 11, wherein a center of the cup cover is provided with a vacuum display and purge valve assembly.

19. A high-speed food processor, comprising a main machine and a stirring cup connected to the main machine in a matched manner, wherein a vacuum pump is provided in the main machine, and the stirring cup is the stirring cup of the high-speed food processor of claim 11.

20. A high-speed food processor, comprising a main machine and a stirring cup connected to the main machine in a matched manner, wherein a vacuum pump is provided in the main machine, and the stirring cup is the stirring cup of the high-speed food processor of claim 12.

21. A high-speed food processor, comprising a main machine and a stirring cup connected to the main machine in a matched manner, wherein a vacuum pump is provided in the main machine, and the stirring cup is the stirring cup of the high-speed food processor of claim 13.

22. A high-speed food processor, comprising a main machine and a stirring cup connected to the main machine in a matched manner, wherein a vacuum pump is provided in the main machine, and the stirring cup is the stirring cup of the high-speed food processor of claim 14.

23. A high-speed food processor, comprising a main machine and a stirring cup connected to the main machine in a matched manner, wherein a vacuum pump is provided in the main machine, and the stirring cup is the stirring cup of the high-speed food processor of claim 15.

24. A high-speed food processor, comprising a main machine and a stirring cup connected to the main machine in a matched manner, wherein a vacuum pump is provided in the main machine, and the stirring cup is the stirring cup of the high-speed food processor of claim 16.

25. A high-speed food processor, comprising a main machine and a stirring cup connected to the main machine in a matched manner, wherein a vacuum pump is provided in the main machine, and the stirring cup is the stirring cup of the high-speed food processor of claim 17.

26. A high-speed food processor, comprising a main machine and a stirring cup connected to the main machine in a matched manner, wherein a vacuum pump is provided in the main machine, and the stirring cup is the stirring cup of the high-speed food processor of claim 18.
